(19) United States
(12) Patent Application Publication
(10) Pub. No.: US 2018/0150387 A1
(43) Pub. Date: May 31, 2018

(54) TESTING APPLICATIONS USING VIRTUAL REALITY

(71) Applicant: ENTIT Software LLC, Sunnyvale, CA (US)

(72) Inventors: Olga Kogan, Yehud (IL); Yaniv Sayers, Yehud (IL)

(21) Appl. No.: 15/575,404

(22) PCT Filed: May 31, 2015
(86) PCT No.: PCT/US2015/033441

§ 371 Date: Nov. 20, 2017

(51) Int. Cl. G06F 11/36; G06T 11/60

(52) U.S. Cl. CPC G06F 11/3664; G06F 11/3684; G06F 3/048; G06T 11/60; G06F 11/3688

(57) ABSTRACT

Examples relate to testing applications using virtual reality. In one example, a computing device may: cause display of a viewable portion of a virtual environment on a VR display of the VR device: cause display of a virtual user device within the viewable portion of the virtual environment, the virtual user device corresponding to a hardware device that is running an application under test (AUT); cause display, on the virtual user device, of a virtual user interface of the AUT; receive feedback data indicating i) a change in the virtual environment, ii) a change in a state of the AUT, or iii) an interaction with the virtual user device; and in response to receiving feedback data, cause display of an updated viewable portion of the virtual environment on the VR display.

### BACKGROUND

Applications are designed for use on many different types of computing devices, such as server computers, laptop computers, tablet computers, mobile phones, wearable computing devices, and embedded computing devices, such as those included in many consumer appliances and vehicles, to name a few. Applications are often tested during and after development, e.g., for the purposes of identifying errors and potential improvements.

### BRIEF DESCRIPTION OF THE DRAWINGS

The following detailed description references the drawings, wherein:

FIG. 1 is a block diagram of an example computing device for testing applications using virtual reality.

FIG. 2 is an example data flow for testing applications using virtual reality.

FIG. 3 is an illustration of an example virtual environment depicting the use of virtual reality to test an application.

FIG. 4 is a flowchart of an example method for testing applications using virtual reality.

### DETAILED DESCRIPTION

Applications for many different computing devices are often used to interact with the physical world. For example, a mobile phone application may be used to navigate through a city, a theme park, or a retail store; an automobile display application may be used to track and display a car's location, speed, fuel level, etc.; and an application running on a wearable computing device may make use of near-field communications (NFC) to interact with other nearby NFC devices. To test user experience and obtain user feedback on these and other types of applications, virtual reality (VR) may be used to simulate, for a user, a physical world experience, without the need for real-world, or on location, testing.

Testing applications using virtual reality may have many advantages. For example, many different situations may be simulated, enabling the testing of user experience and feedback in a variety of situations, including situations that may only occur rarely in the physical world. Testing applications using VR may be safer, e.g., as in the case of testing an automobile heads-up display (HUD) application. VR testing may also make testing available to a wider audience, e.g., rather than needing to interact with the physical world, or a particular location within the physical world, testing may be performed in any location.

By way of example, a mobile phone application for navigating within a store, e.g., to find various products for purchase, may be tested using a VR system. A VR headset, worn by a user, may display a virtual store and a virtual phone to the user. The user interface of the application being tested, i.e., the application under test (AUT), may be displayed on the virtual phone. The user may test the application by interacting with the environment and/or the virtual phone. For example, in a situation where the AUT provides a map of the store and navigates the user to a particular product, the user may move around within the virtual store, observing the behavior of the AUT on the virtual phone. In this example, many aspects of the AUT may be tested, such as the accuracy of positional tracking, the accuracy of the destination with respect to the particular product, the usability of the AUT, interactions between the user and the virtual phone and/or the AUT, and the overall user experience.

The system for testing applications may be configured in a variety of ways, with functionality being spread across multiple devices or included in a single device. Further details regarding potential configurations, and for the testing applications using virtual reality, are described in further detail in the paragraphs that follow.

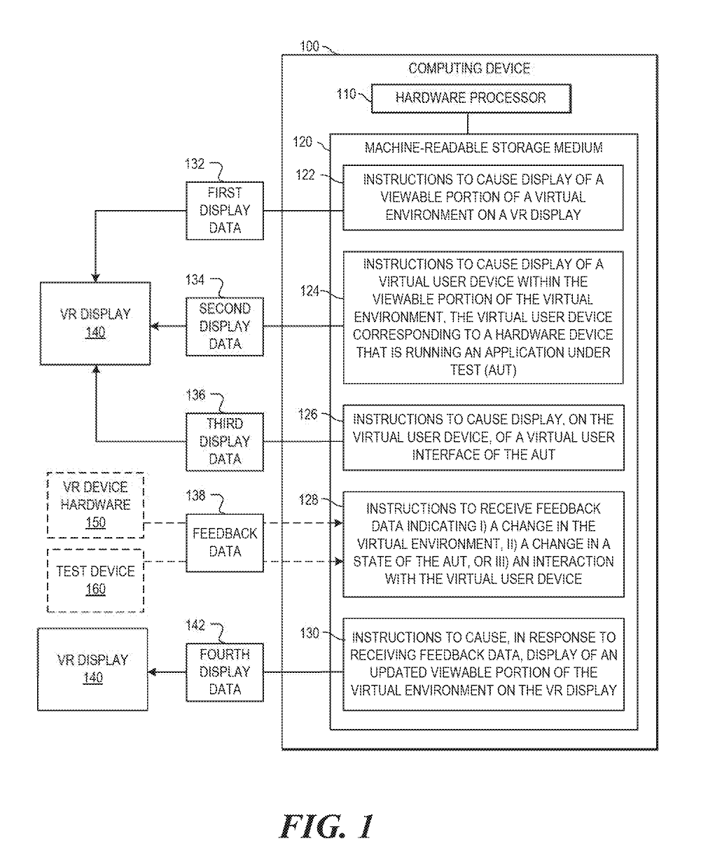

Referring now to the drawings, FIG. 1 is a block diagram of an example computing device 100 for testing applications using virtual reality. Computing device 100 may be, for example, a server computer, a personal computer, a mobile computing device, a virtual reality device, or any other electronic device suitable for processing data. In the embodiment of FIG. 1, computing device 100 includes hardware processor 110 and machine-readable storage medium 120.

Hardware processor 110 may be one or more central processing units (CPUs), semiconductor-based microprocessors, and/or other hardware devices suitable for retrieval and execution of instructions stored in machine-readable storage medium 120. Hardware processor 110 may fetch, decode, and execute instructions, such as 122-130, to control the process for testing an application using virtual reality. As an alternative or in addition to retrieving and executing instructions, hardware processor 110 may include one or more electronic circuits that include electronic components for performing the functionality of one or more of instructions.

A machine-readable storage medium, such as 120, may be any electronic, magnetic, optical, or other physical storage device that contains or stores executable instructions. Thus, machine-readable storage medium 120 may be, for example, Random Access Memory (RAM), an Electrically Erasable Programmable Read-Only Memory (EEPROM), a storage device, an optical disc, and the like. In some implementations, storage medium 120 may be a non-transitory storage medium, where the term “non-transitory” does not encompass transitory propagating signals. As described in detail below, machine-readable storage medium 120 may be encoded with a series of executable instructions: 122-130, for testing applications using virtual reality.

A VR display 140 is in communication with the computing device 100, and is operable to display data for a user, such as a virtual environment, a virtual computing device, and a virtual representation of an application being tested. In implementations where the computing device 100 is included in a VR device, the VR display 140 may be the screen.

In some implementations, VR device hardware 150 may be communication with the computing device 100, and is operable to provide feedback to the computing device 100. For example, the VR device hardware 150 may be a controller for controlling movement of the user within a virtual environment or sensors for tracking head movements and orientation. While VR device hardware 150 is represented in FIG. 1 by a single box, multiple and varying types of VR device hardware 150 may be used for providing feedback to the computing device 100.

In some implementations, test device 160 may be in communication with the computing device 100, and is operable to provide feedback to the computing device 100. For example, the test device 160 may be a computing device on which an AUT is running, and the feedback may data that comes from the AUT or from other applications running on the test device 160.

As shown in FIG. 1, the computing device 100 executes instructions (122) to cause display of a viewable portion of a virtual environment on a VR display 140, e.g., of a VR device. Using the example situation of an application being tested within a virtual store, the virtual environment may be a representation of the store using three dimensional graphics. The viewable portion may be the portion of the virtual environment within the user's field of view, e.g., the portion of the virtual store than the user wearing a VR device would see. The computing device 100 provides the VR display 140 with first display data 132 that causes the display of the viewable portion of the virtual environment.

The source of the first display data 132 may vary. For example, the computing device 100 may store pre-configured first display data 132 on an attached or remote machine-readable storage medium, such as storage medium 120. In some implementations, a separate virtual environment simulation module, running on the computing device 100 or a separate device, may provide the first display data 132 and/or data including a configuration of the virtual environment. For example, the developer of the AUT may provide the computing device with details of a virtual store environment, such as the placement and attributes of objects within the environment, and that information may be used by the computing device to produce the particular virtual environment.

The virtual environment is designed to simulate a real world environment, and may include a variety of objects and details to make the simulation more realistic. For example, a virtual store environment may include various products on shelves, customers moving throughout the store, shopping carts, checkout lanes, store employees, and, in some implementations, may incorporate sounds, smells, and other sensory aspects capable of being simulated by technology in communication with the VR device. The virtual environment may also include virtual representations of objects that interact with the AUT. For example, wireless beacons, such as Wi-Fi and/or Bluetooth devices placed throughout the virtual store, may be included in the virtual environment for tracking the position of a user of the AUT. Other examples devices may include other devices running the AUT or other applications, point-of-sale devices and applications, smart tags capable of being scanned by a device running the AUT, and other types of objects capable of interacting with the AUT.

The virtual environment may include additional aspects that affect the AUT and/or the virtual device on which the AUT runs. For example, wireless beacons included in the virtual environment may have simulated signal patterns and simulated strength. Other objects within the environment, such as store shelving units, may have simulated interference attributes to simulate signal interference, e.g., between wireless beacons and the virtual device running the AUT. The additional aspects may vary greatly, and may be designed to make the virtual environment as realistic as possible or to simulate specific situations to be tested.

The computing device 100 executes instructions (124) to cause display of a virtual user device within the viewable portion of the virtual environment. The virtual user device corresponds to a hardware device that is running an application under test (AUT). For example, when testing a mobile phone application, the instructions 124 may send second display data 134 to the VR display, the second display data 124 including data operable to cause the VR display to display, within the viewable portion of the virtual environment, a virtual phone. The virtual user device to be displayed may vary, e.g., depending on the type of device on which the AUT is to be tested. In some implementations, the second display data 134, or data used by the computing device 100 to generate the second display data, may be provided by the hardware device that is running the AUT.

The computing device 100 executes instructions (126) to cause display, on the virtual user device, of a virtual user interface of the AUT. In the example situation where the AUT is a mobile phone application for navigating through a retail store, the third display data 136 may cause display of a map of the store, including a marker for the position of the user within the store and a destination where a particular product is located. The user interface is displayed on the virtual user device, e.g., on the virtual mobile phone.

In some implementations, the third display data 136 is provided to the computing device 100 by the hardware device running the AUT. For example, a mobile phone running the AUT may “cast” it's screen to the computing device 100, which may in turn cause the VR display 140 to depict the screen cast, e.g., enabling the virtual user interface shown on the VR display to match the user interface displayed on the actual mobile phone.

The computing device 100 executes instructions (128) to receive feedback data 138 indicating i) a change in the virtual environment, ii) a change in a state of the AUT, or iii) an interaction with the virtual user device. As shown in FIG. 1, feedback data 138 may be provided by a VR hardware device 150 and/or a test device 160. In some implementations, the VR hardware device 150 may be, for example, a controller used to move the user within the virtual environment or a combination of sensors used to determine the orientation of the user's head. In some implementations, the test device 160 may be a computing device on which the AUT is running, such as a mobile phone or a test computing running the AUT.

Feedback that indicates a change in the virtual environment may be, for example, the addition, removal, or change of an object within the viewable or non-viewable portion of the virtual environment, including any change in the virtual representation of the user. In the retail store example, this may include the addition or removal of shelving units, other virtual shoppers and/or employees, adding or removing wireless beacons or changing their signal strength, and adding or removing point-of-sale devices with which the AUT may interact, to name a few. Another example of feedback that indicates a change in the virtual environment includes a change in a position, within the virtual environment, of a virtual user of the VR device or a change in a view orientation of a virtual user of the VR device. These changes may be tracked, for example, by the VR device itself and used, for example, to determine location based accuracy of the AUT and for testing movement-based aspects of an AUT.

Feedback that indicates a change in the state of the AUT may be, for example, changes that occur in the AUT without a change in the environment or user interaction, such as timed releases of information or changes to AUT settings or preferences. Using the retail store example, this may include periodically pushing a coupon or advertisement to the AUT for viewing by the user. Feedback that indicates an interaction with the virtual user device may be, for example, data sent to the virtual user device by another virtual object or an interaction with the virtual user device, or real user device running the AUT, by user input. Using the retail store example, this may include pushing a coupon or advertisement to the AUT for display when the user is within a certain range—e.g., determined by signal strength—of a beacon, or a button press or gesture or spoken instructions provided by the user of the virtual user device, e.g., detected by user input provided to the actual hardware device that corresponds to the virtual user device. Many other types of feedback data 138 may be provided to the computing device 100 instead of or in addition to the examples described above.

The computing device 100 executes instructions (130) to cause, in response to receiving the feedback data 138, display of an updated viewable portion of the virtual environment on the VR display 140. The fourth display data 142 provided to the VR display 140 may be, for example, data that causes a change to the user interface of the virtual user device depicted in the example environment. In the retail store example, in a situation where feedback data 138 indicates the position of the virtual user is within a certain range of a particular beacon, the fourth display data 142 may cause a coupon to be displayed on the virtual user device, e.g., a coupon for a product located near the user's virtual location within the virtual environment.

The computing device 100, using the foregoing instructions, is designed to produce a virtual experience that closely simulates a real-world experience for a user of the VR device, which enables testing of the AUT in conditions that resemble those that may be encountered by a user in the real world. In the virtual store example, a tester may determine how various things affect the user experience. For example, by tracking the user's gaze, testers may be able to determine if pushing a coupon to the virtual user device causes the user to a) look at the virtual user device, and/or b) find the product associated with the coupon. A distance threshold from a wireless beacon may be adjusted to help testers identify a threshold designed to maximize the chance that a user will find the product associated with the coupon. The speed with which a user moves throughout the virtual environment—measured, for example, by the VR device—may also have observable value to a tester, e.g., in the retail store example, a user may be moving too quickly for beacons to provide timely data, which may result in AUT developers implementing a speed threshold for determining when a coupon is eligible to be served to a nearby user. In addition, testers may be able to determine how signal interference and/or degradation affects the user experience. For example, if there are portions of the virtual store where signal is weak, testers may be able to determine if users are able to find what they are looking for or follow navigation instructions accurately. Testers may add, remove, or change the position of wireless beacons used for navigation throughout the virtual environment and determine how various configurations affect the user experience. In addition, interactions with other virtual devices, such as virtual point-of-sale devices, smart tags on store shelving units or products, or other virtual user devices running the AUT, may all be tested in the simulated real-world environment.

While the computing device 100 implements one possible configuration of a device for using virtual reality to test applications, further examples and details regarding the use of virtual reality in application testing are provided in the paragraphs that follow.

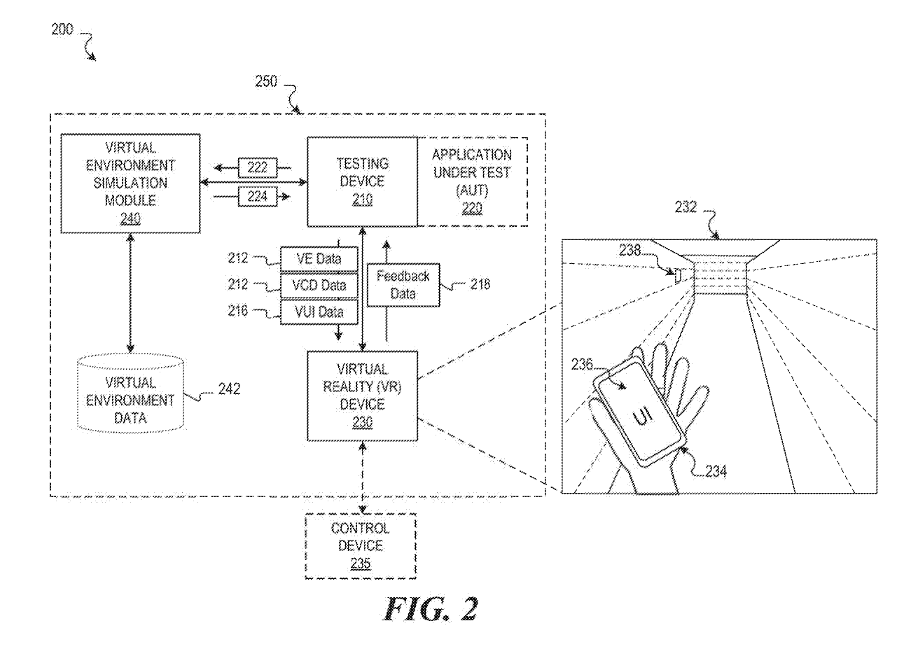

FIG. 2 is an example data flow 200 for testing applications using virtual reality. The data flow 200 depicts a testing device 210, which may be implemented in a computing device, such as the computing device 100 described above with respect to FIG. 1. In some implementations, the testing device 210 is the hardware device that corresponds to the virtual hardware device, e.g., the device on which the AUT 220 is to be tested. In some implementations, the testing device 210 emulates or simulates the hardware device that corresponds to the virtual hardware device, e.g., a computer may run the AUT 220, alone or an addition to other testing tools, on an emulator that emulates a hardware device. The AUT 220 may be running on the testing device 210 and/or on a separate device in communication with the testing device 210. For example, the testing device 210 may be a computing device running testing tools while the AUT 220 is running on a hardware device in communication with the testing device 210.

The VR device 230 is in communication with the testing device 210, and is the device responsible for displaying the virtual environment 232 to a user. For example, the VR device 230 may be a virtual reality headset, which may include, among other things, a display screen and/or speakers. The VR device 230 is optionally in communication with one or more control devices, such as control device 235, for providing input to the VR device 230. For example, a user may remain stationary in the real world and use a joystick controller to move the virtual representation of the user within the virtual environment 232. Other forms of controlling the VR device 230 may also be used and may include, for example, sensors for detecting movement and/or orientation of the user's head, buttons, a touchpad, and/or a microphone for receiving voice commands, to name a few.

The virtual environment simulation module 240 is in communication with the testing device 210 and a virtual environment data 242 storage device. The virtual environment simulation module 240 may be used to provide the test device 210 with data to be represented in the virtual environment 232. In the retail store application testing example, the data may include the layout of the virtual store, the placement of all objects—including shelves, wireless beacons, other people, etc.—within the store, and attributes of those objects. The data may also include the virtual assets, e.g., the graphic components and art required to produce the virtual environment on the VR device. Movements of virtual people within the store, sounds that occur in the store, and other sensations that can be simulated may also be included in the virtual environment data 242 for use in simulating a real-world environment. The virtual environment simulation module 240 may be implemented, in whole or in part, in the testing device 210 and/or a separate computing device. In some implementations, the virtual environment simulation module 240 is included in or in communication with the VR device 230.

While the testing device 210, AUT 220, VR device 230, virtual environment simulation module 240, and virtual environment data 242 are all depicted separately, multiple configurations are possible. And indicated by box 250, each of the foregoing components may be implemented in single device.

In the example data flow 200, when the AUT is to be tested, the test device 210 provides virtual environment (VE) data 212 to the VR device 230. The virtual environment data 212 specifies the virtual environment 232 in which the AUT 220 is to be tested. As discussed above, in the virtual retail store example, this includes data specifying the details of the virtual store layout and objects within the virtual store.

In the example data flow 200, the testing device 210 also provides virtual computing device (VCD) data 214 to the VR device 230. The virtual computing device data 214 specifies the virtual computing device 234 on which the AUT 220 is to de tested. The virtual computing device 234 corresponds to the computing device, e.g., the actual mobile phone on which the AUT 220 is to be run and/or tested. For example, VCD data 214 for a mobile phone may include graphical data required to produce a virtual version of the mobile phone and, in some implementations, features of the mobile phone to be used during testing, e.g., an earpiece if one is being used, a current state of the mobile phone including other applications running on it, and settings—such as phone volume level and/or screen brightness level.

The test device 210 also provides virtual user interface (VUI) data 216 to the VR device 230. The virtual user interface data 216 specifies data to be displayed, by the VR device 230, on the virtual display 236 of the virtual computing device 234. For example, the VUI data 216 may include the user, interface of the AUT 220 for reproduction on the virtual mobile phone display 236. As discussed above, the VUI data may be provided by screen casting from the testing device 210 or, in implementations where the testing device is separate from the hardware device on which the AUT is being simulated, the separate hardware device, e.g., an actual mobile phone running the AUT.

The virtual environment 232 depicted in the example data flow 200 depicts a scene that places a user of the VR device 230 in a virtual store near shelving units. The virtual environment 232 includes a beacon device 238, which may be a Bluetooth enabled beacon that, in the example AUT 200, is designed to push a coupon to display when the virtual user device 234 is within range of the beacon device 238.

The VR device 230 provides feedback data 218 to the testing device 210. The feedback data 218 indicates i) a change in position, within the virtual environment 232, of the virtual user of the VR device 230, or ii) a change in a view orientation of a virtual user of the VR device 230. For example, if the user either causes the virtual user to move within the virtual environment 232 or looks around within the virtual environment 232, feedback data 218 indicating the change is sent to the testing device 210.

The testing device 210 provides the virtual environment simulation module 240 with sensory data 222 that is based on the feedback data 218. The sensory data indicates the position and/or orientation of the virtual user of the VR device 230. In some implementations, the virtual environment simulation module 240, alone or in conjunction with the testing device 210, may use the sensory data 222 to determine a new state of the virtual computing device 234. For example, when if the virtual user moved closer to the beacon 238, the virtual environment simulation module 240 may determine a simulated signal strength level for wireless signal received by the virtual user device 234.

The virtual environment simulation module 240 provides the testing device 210 with computing device state data 224 that indicates the change in the simulated state of the computing device being simulated. The testing device 210 may use the computing device state data 224 and the AUT 220 to obtain updated VUI data. For example, in a situation where the AUT 220 is configured to display a coupon when the virtual computing device 234 is within a certain signal strength, when the computing device state change data 224 indicates that the virtual computing device 234 is within the certain signal strength level, the AUT 220 may provide updated VUI data that includes a graphical representation of a coupon for display on the virtual display 236.

The updated VUI data is provided to the VR device 230, which causes the virtual display 236 of the virtual user device 234 to be updated. For example, the coupon may be displayed. Other example use cases in the retail store example may include: prompting the user to interact with the beacon 238 using a NFC connection to obtain a coupon, using the beacon 238 and other beacons to determine the user's location within the virtual store and provide a map indicating the location for display, permitting the user to use the virtual computing device 234 to scan a smart tag, e.g., by taking a picture of a virtual representation of a smart tag that causes the AUT to display more information about a particular product, and facilitating a virtual interaction between the virtual computing device 234 and another virtual device, such as a point-of-sale device.

In some implementations, the testing device 210 may obtain data indicating an interaction with the virtual device 234. For example, if a user interacts with the virtual user device 234—e.g., within the virtual environment 232 or in the real world with a real computing device that is screen casting to the virtual computing device, the VR device 230 or computing device running the AUT—whichever was used to interact—may provide data indicating the interaction to the testing device 210. In this situation, the testing device 210 may again obtain updated AUT state data that is based or the interaction. For example, if a user interacts with the AUT by using voice commands to search for a product within the virtual store, the AUT may change state by displaying a search or navigational interface. The testing device 210 may then provide data to the VR device 230 that causes display of the updated user interface within the virtual environment 232.

In some implementations, an update to the state of the AUT and virtual environment display may be caused by a change in the virtual environment 232. For example, if a tester changes the configuration of the virtual environment or objects within it, this may affect the state of the AUT, which may cause another update to the AUT display. In some implementations, the AUT may cause a change in the state of the AUT. For example, in situations where the AUT uses a time-based release of information, the AUT may determine to update the display based on its configuration. As with the examples above, in this situation the testing device 210 will also cause the VR device 230 to update the virtual display 236 of the virtual computing device 234.

As discussed above, many aspects of the user experience with the AUT may be tested when using virtual reality. For example, the range at which certain events are triggered may affect the user's ability to find a particular beacon or product; audible noise within the virtual environment may affect the user's ability to hear any audible notifications the AUT causes the virtual computing device 234 to produce; and inaccurate positional tracking may affect how a user interacts with the AUT or moved around the virtual environment 232. Many other aspects of an AUT may be tested in a wide variety of environments.

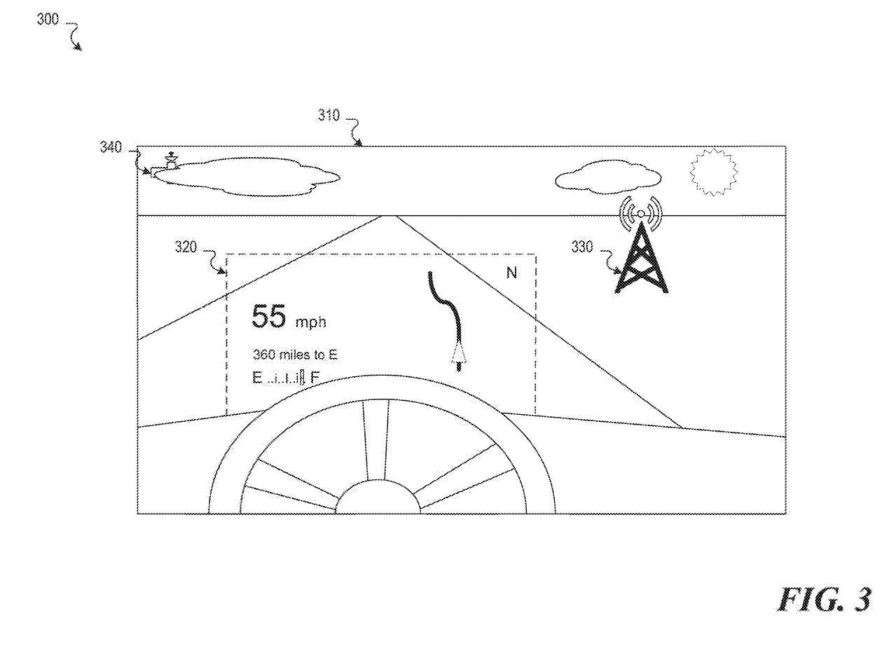

FIG. 3 is an illustration of an example virtual environment 310 depicting the use of virtual reality to test an application. The application being tested, e.g., the AUT, is a heads-up-display (HUD) for a vehicle. The AUT causes a semi-transparent HUD to display various information about the vehicle, such as the travelling speed, fuel level, and navigational information. Testing the AUT using virtual reality may, in this example, be safer for a user than testing the AUT would be in the real world, and many conditions—such as weather, obstructions, other vehicles, and distractions—may be included in the virtual environment 310 for testing situations that might not be encountered often in the real world.

The example virtual environment 310, depicts a cellular tower 330 and a satellite 340, which may be in communication with the virtual computing device causing display of the HUD, such as a computer included in the automobile. Many things may affect the signal between the cellular tower 330, satellite 340, other cellular towers and satellites that are not depicted, and the virtual computing device. As noted above, weather may affect signal, e.g., GPS signal sent from a GPS; obstructions, such as bridges and buildings, may also affect signal. Many other aspects, aside from how signals affect vehicle navigation, may be tested, such as the user experience with respect to various notifications or other information that is displayed on the HUD. Eye tracking technology may be used to determine where user's direct their attention, allowing developers of the AUT to determine, for example, which notifications are most useful to users without being disruptive or distracting. Facial expression tracking and emotion measurement technology may be implemented to determine how a user reacts or feels in different situations.

Many other applications in many different settings and on many different devices may be tested using virtual reality. For example, a smart watch application may be used to navigate through a theme park and receive location-based content, testing of which may be performed using virtual reality. As another example, a medical application designed to run on a tablet computer and assist with medical procedures may be tested using virtual reality, allowing it to be tested on a virtual patient. In addition, the flexibility of virtual reality configurations may allow for a single VR testing system to be used to simulate and test a variety of different applications on a variety of different devices.

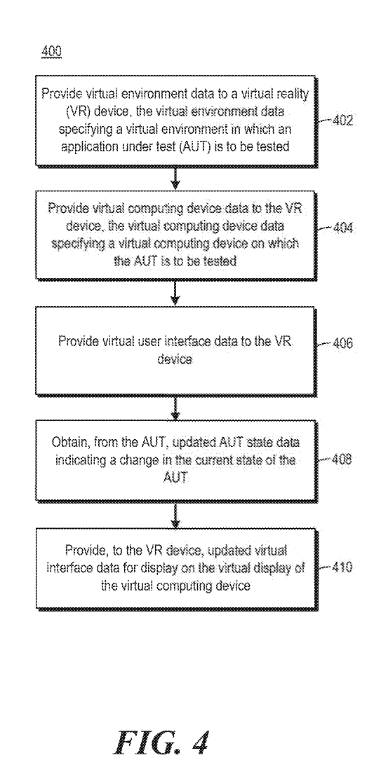

FIG. 4 is a flowchart of an example method 400 for testing applications using virtual reality. The method may be implemented by a computing device, such as computing device 100 described above with reference to FIG. 1.

Virtual environment data is provided to a virtual reality (VR) device, the virtual environment data specifying a virtual environment in which an application under test (AUT) is to be tested (402). In the vehicle HUD example, the virtual environment may specify the virtual environment as the inside of an automobile on a road or in a parking lot.

Virtual computing device data is provided to the VR device, the virtual computing device data specifying a virtual computing device on which the AUT is to be tested (404). For example, a test computing device may provide data specifying that an on-board computer of the vehicle is the computing device on which the HUD application is to be tested.

Virtual user interface data is provided to the VR device (406). The virtual user interface data is i) based on a current state of the AUT, and ii) specifies data to be displayed, by the VR device, on a virtual display of the virtual computing device. For example, virtual interface data for the vehicle HUD application may be based on a simulated location and status of the vehicle, as well as the status of the HUD application, e.g., actively navigating and/or tracking speed, and the data displayed on the HUD may be specified by the virtual user interface data.

Updated AUT state data is obtained from the AUT, indicating a change in the current state of the AUT (408). For example, the AUT running on the test computing device may change state, e.g., a tester may change the AUT while it is running, altering the data to be displayed on the vehicle HUD.

Updated virtual user interface data is provided to the VR device for display on the virtual display of the virtual computing device (410). In the example situation where the information to be displayed on the vehicle HUD is to be changed, the test computing device may provide, to the VR device, the information necessary to update the virtual HUD.

The foregoing disclosure describes a number of example implementations for testing applications using virtual reality. As detailed above, examples provide a mechanism for simulating the real world and applications within a virtual environment and potential applications of a system that is capable of providing a mechanism to test applications using virtual reality.

We claim:

1. A non-transitory machine-readable storage medium encoded with instructions executable by a hardware processor of a virtual reality (VR) device for testing applications using virtual reality, the machine-readable storage medium comprising instructions to cause the hardware processor to:
cause display of a viewable portion of a virtual environment on a VR display of the VR device;
cause display of a virtual user device within the viewable portion of the virtual environment, the virtual user device corresponding to a hardware device that is running an application under test (AUT);
cause display, on the virtual user device, of a virtual user interface of the AUT;
receive feedback data indicating i) a change in the virtual environment, ii) a change in a state of the AUT, or iii) an interaction with the virtual user device; and
in response to receiving feedback data, cause display of an updated viewable portion of the virtual environment on the VR display.

2. The storage medium of claim 1, wherein the feedback data indicates a change in the virtual environment, the change in the virtual environment comprising at least one of:
a change in a position, within the virtual environment, of a virtual user of the VR device;
a change in a view orientation of a virtual user of the VR device;
an addition, removal, or change of an object within the viewable portion of the virtual environment; or
an addition, removal, or change of an object within a non-viewable portion of the virtual environment.

3. The storage medium of claim 2, wherein the updated viewable portion of the virtual environment includes an updated virtual user interface of the AUT.

4. The storage medium of claim 1, wherein:
the feedback data is received from a separate computing device;
the feedback data indicates a change in the state of the AUT, and
the updated viewable portion of the virtual environment includes an updated virtual user interface of the AUT.

5. The storage medium of claim 1, wherein:
the feedback data indicates an interaction with the virtual user device, and
the updated viewable portion of the virtual environment includes an updated virtual user interface of the AUT.

6. The storage medium of claim 1, wherein the virtual environment includes a second virtual device that corresponds to a second AUT, and wherein the instructions further cause the hardware processor to:
receive second AUT data from a separate computing device; and
in response to receiving second AUT data, cause display, on the virtual user device, of an updated virtual user interface of the AUT.

7. The storage medium of claim 1, wherein:
the feedback data indicates a change in position, within the virtual environment, of a virtual user of the VR device, and
the updated viewable portion of the virtual environment is based on the change in position, and wherein the instructions further cause the hardware processor to:
send data indicating the change in position to the hardware device running the AUT;
receive, from the hardware device, AUT user interface data, the AUT user interface data being based on the change in position; and
cause display of an updated virtual user interface of the AUT, the updated virtual user interface being based on the AUT user interface data.

8. A computing device for testing applications using virtual reality, the computing device comprising:
a hardware processor; and
a data storage device storing instructions that, when executed by the hardware processor, cause the hardware processor to:
provide virtual environment data to a virtual reality (VR) device, the virtual environment data specifying a virtual environment in which an application under test (AUT) is to be tested;
provide virtual computing device data to the VR device, the virtual computing device data specifying a virtual computing device on which the AUT is to be tested, the virtual computing device corresponding to the computing device;
provide virtual user interface data to the VR device, the virtual user interface data specifying data to be displayed, by the VR device, on a virtual display of the virtual computing device;
receive, from the VR device, feedback data indicating i) a change in position, within the virtual environment, of a virtual user of the VR device, or ii) a change in a view orientation of a virtual user of the VR device;
provide a virtual environment simulation module with sensory data indicating at least one of a position or orientation of the virtual user of the VR device, the sensory data being based on the feedback data;
receive, from the virtual environment simulation module, computing device state data indicating a change in a simulated state of the computing device;
obtain, using the AUT, updated virtual user interface data that is based on the change in the simulated state of the computing device; and
provide, to the VR device, the updated virtual user interface data for display on the virtual display of the virtual computing device.

9. The computing device of claim 8, wherein the instructions further cause the hardware processor to:
obtain interaction test data indicating an interaction with the virtual user device;
obtain updated AUT state data using the interaction test data, the updated AUT state data indicating a change in a state of the AUT; and
provide, to the VR device, updated display data for display on a VR display of the VR device, the updated display data being based on the updated AUT state data.

10. The computing device of claim 8, wherein the instructions further cause the hardware processor to:
obtain environment test data indicating a change in the virtual environment;
obtain updated AUT state data using the environment test data, the updated AUT state data indicating a change in a state of the AUT; and
provide, to the VR device, updated display data for display on a VR display of the VR device, the updated display data being based on the updated AUT state data.

11. The computing device of claim 8, wherein the instructions further cause the hardware processor to:
receive, from the AUT, updated AUT state data indicating a change in a state of the AUT; and
provide, to the VR device, updated display data for display on a VR display of the VR device, the updated display data being based on the updated AUT state data.

12. A method for testing applications using virtual reality implemented by at least one data processor, the method comprising:
providing virtual environment data to a virtual reality (VR) device, the virtual environment data specifying a virtual environment in which an application under test (AUT) is to be tested;
providing virtual computing device data to the VR device, the virtual computing device data specifying a virtual computing device on which the AUT is to be tested;
providing virtual user interface data to the VR device, the virtual user interface data i) being based on a current state of the AUT, and ii) specifying data to be displayed, by the VR device, on a virtual display of the virtual computing device;
obtain, from the AUT, updated AUT state data indicating a change in the current state of the AUT; and
provide, to the VR device, updated virtual interface data for display on the virtual display of the virtual computing device, the updated virtual interface data being based on the updated AUT state data.

13. The method of claim 12, further comprising:
receiving, from the VR device, feedback data indicating i) a change in position, within the virtual environment, of a virtual user of the VR device, or ii) a change in a view orientation of a virtual user of the VR device;
providing a virtual environment simulation module with sensory data indicating at least one of a position or orientation of the virtual user of the VR device, the sensory data being based on the feedback data;
receive, from the virtual environment simulation module, computing device state data indicating a change in a simulated state of the computing device;
obtain, using the AUT, second updated virtual user interface data that is based on the change in the simulated state of the computing device; and
provide, to the VR device, the second updated virtual user interface data for display on the virtual display of the virtual computing device.

14. The method of claim 12, further comprising:
obtaining interaction test data indicating an interaction with the virtual user device;
obtaining second updated AUT state data using the interaction test data, the second updated AUT state data indicating a second change in the current state of the AUT; and
provide, to the VR device, updated display data for display on a VR display of the VR device, the updated display data being based on the second updated AUT state data.

15. The method of claim 12, further comprising:
obtaining environment test data indicating a change in the virtual environment;
obtaining updated AUT state data using the environment test data, the updated AUT state data indicating a change in a state of the AUT; and
providing, to the VR device, updated display data for display on a VR display of the VR device, the updated display data being based on the updated AUT state data.
